(19) United States
(12) Patent Application Publication
(10) Pub. No.: US 2025/0272382 A1
(43) Pub. Date: Aug. 28, 2025

(54) IMAGE FORMING APPARATUS WITH PASSWORD STRENGTH DISPLAY FUNCTION

(71) Applicant: CANON KABUSHIKI KAISHA, Tokyo (JP)

(72) Inventor: KYOHEI TAKEDA, Tokyo (JP)

(21) Appl. No.: 19/063,080

(22) Filed: Feb. 25, 2025

(30) Foreign Application Priority Data
Feb. 28, 2024 (JP) 2024-028263

(51) Int. Cl. G06F 21/46; B41J 3/46; G06F 3/12; G06F 16/958

(52) U.S. Cl. CPC G06F 21/46; B41J 3/46; G06F 3/1222; G06F 3/1238; G06F 3/1284; G06F 16/986

(57) ABSTRACT

An image forming apparatus configured to register a password of a user who uses an image forming function, and/or edit the password, includes at least one first processor and at least one first memory coupled to the first processor and having stored thereon instructions, when executed by the first processor, and cooperating to act as a password strength calculation unit configured to calculate a strength of the password, a request unit configured to request a display of a screen including a password strength meter for indicating a strength level determined based on the calculated strength, and a setting unit configured to set a strength level of the password to be set on the image forming apparatus, wherein the strength level determined based on the calculated strength and the set strength level are compared to change a display content of the password strength meter based on a result of the comparison.

### BACKGROUND

### Field of the Disclosure

The present disclosure relates to an image forming apparatus with a password strength display function, a control method for the image forming apparatus, and a storage medium.

### Description of the Related Art

Passwords are the most widely used authentication method in the world, but cases where users' information is easily stolen occur frequently, because the users set weak passwords.

As a guideline regarding the password security, there is NIST SP800-63-3 proposed by National Institute of Standards and Technology (NIST). As one of items to be achieved about the password in this guideline, NIST SP800-63-3 recommends that a guidance such as a password strength meter should be provided when a user sets a password. As a conventional art related to this guidance, there is a technique discussed in United States Patent Application Publication No. 8108685.

### SUMMARY

According to an aspect of the present disclosure, an image forming apparatus configured to register a password of a user who uses an image forming function, and/or edit the password, includes at least one first processor and at least one first memory coupled to the first processor and having stored thereon instructions, when executed by the first processor, and cooperating to act as a password strength calculation unit configured to calculate a strength of the password input by the user, a request unit configured to request a display of a screen including a password strength meter for indicating a strength level determined based on the calculated strength; and a setting unit configured to set a strength level of the password to be set on the image forming apparatus, wherein the strength level determined based on the calculated strength and the set strength level are compared to change a display content of the password strength meter based on a result of the comparison.

Further features of the present disclosure will become apparent from the following description of exemplary embodiments with reference to the attached drawings.

### BRIEF DESCRIPTION OF THE DRAWINGS

FIG. 1 is a diagram illustrating a network configuration.

FIG. 2 is a block diagram illustrating a hardware configuration of a multifunction peripheral (MFP).

FIG. 3 is a block diagram illustrating a software configuration of the MFP.

FIG. 4 is a diagram illustrating setting screens on a local user interface (UI).

FIG. 5 is a diagram illustrating user management screens.

FIG. 6 is a flowchart illustrating an operation flow of password strength meter display determination processing by the local UI.

FIG. 7 is a diagram illustrating user interfaces of software keyboards.

FIG. 8 is a flowchart illustrating an operation flow of password strength meter display processing by the local UI.

FIG. 9 is a diagram illustrating display contents of the password strength meter.

FIG. 10 is a flowchart illustrating an operation flow performed when a password is set again at a login time.

FIG. 11 is a flowchart illustrating an operation flow of a password strength meter display determination processing by a remote UI.

FIG. 12 is a diagram illustrating password strength meter display screens on the remote UI.

### DESCRIPTION OF THE EMBODIMENTS

There are many websites provided with a password strength meter, the display of which is updated when a user set a password by calculating an input password strength and depending on the calculated strength. The strength level of the password required for the websites is determined in advance, and the user cannot change the strength level to an arbitrary value.

In a case where the password strength meter is mounted on a built-in device such as an image forming apparatus, there is a possibility that the required password strength may be different depending on an environment in which the image forming apparatus is installed.

For this reason, there is an issue that it is difficult, if an administrator cannot set an arbitrary strength level, to have a user set a password satisfying a password strength required by an organization.

The present disclosure is directed to a technique for providing a setting method of a required password strength level.

With reference to the attached drawings, exemplary embodiments of the present disclosure will be described.

As an example of an image forming apparatus to which the present disclosure is applied, a first exemplary embodiment of the present disclosure will be described by using a Multifunction Peripheral (MFP) having image forming functions, such as copy, print, and scan functions, installed in an office as an example.

### <System Configuration>

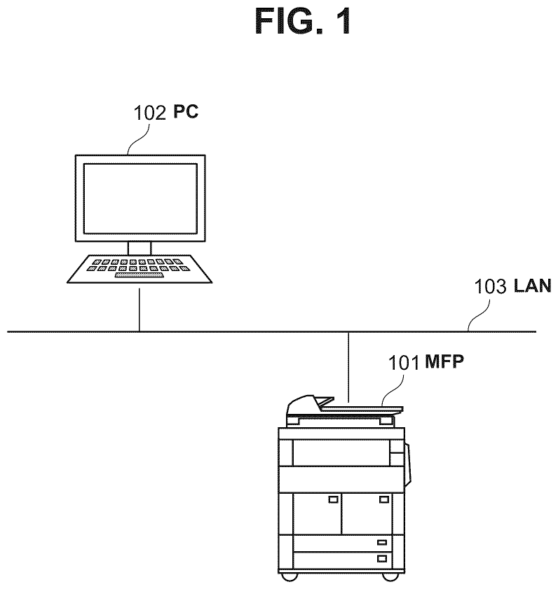

With reference to FIG. 1, a network configuration in an office environment according to the present exemplary embodiment will be described.

An MFP 101 is an MFP to which the present disclosure is applied. The MFP 101 communicates with a personal computer (PC) terminal, for example, a PC 102 connected thereto via a local area network (LAN) 103. A user can use a remote user interface (UI) of the MFP 101 by accessing the MFP 101 from a web browser of the PC 102. The MFP 101 can receive a request to access a print job or a document stored in the MFP 101 from the PC 102. Although the MFP 101 according to the first exemplary embodiment of the present disclosure is installed in an environment of the LAN 103, the MFP 101 may be installed in other environments, but the MFP 101 can adapt to the setting in any environment in which the MFP 101 is installed.

### <Hardware Configuration>

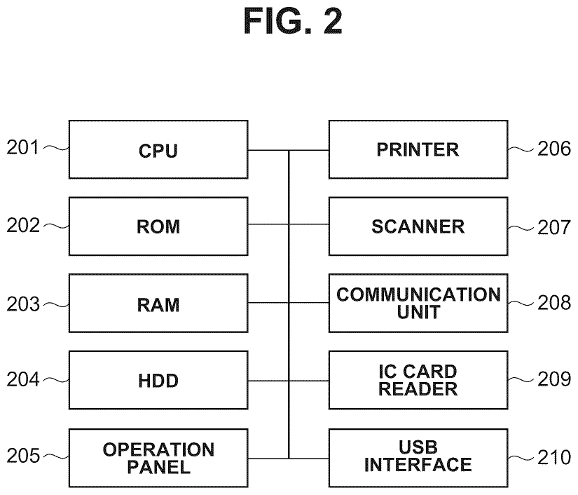

FIG. 2 is a schematic diagram illustrating a hardware configuration of the MFP 101. A central processing unit (CPU) 201 is a processor for controlling operations of the entire MFP 101. A random access memory (RAM) 203 is a volatile memory serving as a work area, and used as a temporary memory area for loading various kinds of control programs stored in a read only memory (ROM) 202 or a hard disk drive (HDD) 204.

The ROM 202 is a non-volatile memory, to store a boot program or the like for the MFP 101. The HDD 204 is a non-volatile hard disk drive with a large-capacity compared with the RAM 203. The HDD 204 stores control programs for the MFP 101. An operating system (OS) and application programs are also stored in the HDD 204.

The CPU 201 executes the boot program stored in the ROM 202 at a start-up time of the MFP 101. This boot program is a program for reading the OS program stored in the HDD 204, and loading the read OS program into the RAM 203. After the CPU 201 executes the boot program, next the CPU 201 executes the OS program loaded in the RAM 203 to control the MFP 101. The CPU 201 stores data to be used for the operation by the control program into the RAM 203, and reads and writes the data.

Assume that one CPU 201 in the MFP 101 executes processing illustrated in flowcharts described below, but the MFP 101 may have a different configuration. For example, a plurality of CPUs or micro processing units (MPUs) can execute the processing of the flowcharts described below by operating in cooperation with each other. Part of the processing described below may be executed by a hardware circuit such as an application specific integrated circuit (ASIC) or a field programmable gate array (FPGA).

An operation panel 205 is a touch-operable display.

A printer 206 is a printer engine for printing print data received from the outside via a communication unit 208 and digital data acquired from a scanner 207.

The scanner 207 is a scanner device for reading a paper document and converting it into digitalized data.

The communication unit 208 is a network interface for connecting to the Internet or an office LAN. An integrated circuit (IC) card reader 209 is a device for reading out information to be used for a user authentication from an IC card, and is necessary to perform an IC card authentication. A universal serial bus (USB) interface 210 is an interface to which a device compliant to USB standards can be attached.

### <Software Configuration>

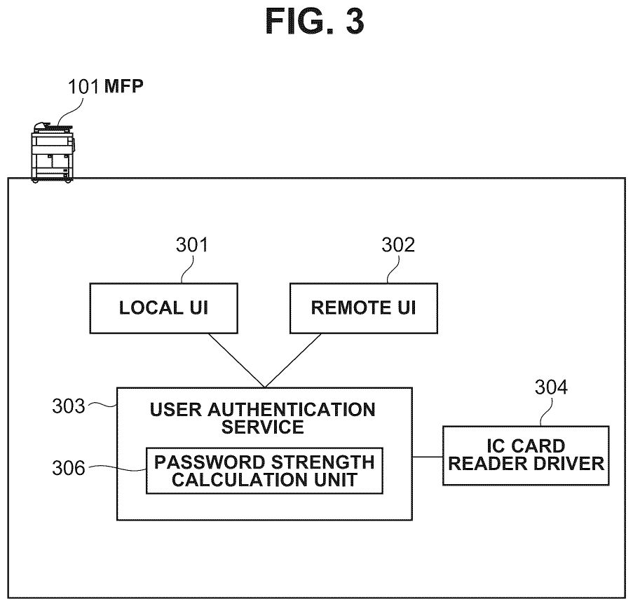

FIG. 3 is a schematic diagram illustrating a software configuration of the MFP 101. A local UI 301 of the MFP 101 provides a user interface for allowing a user who performs a local access to change settings or use functions of the MFP 101, using a display on the operation panel 205.

A remote UI 302 has a HyperText Transfer Protocol (HTTP) server function. The remote UI 302 provides a user interface implemented by HTML to an external apparatus that performs remote access to the MFP 101. The user interface includes screens for using functions of the MFP 101, and for making settings of the MFP 101, and an authentication screen for inputting information regarding a user authentication for using the functions and making the settings.

A user accesses the remote UI 302 using a web browser of the PC 102, and can change the settings of the MFP 101 and use the functions. The web browser of the PC 102 displays a user interface implemented by HTML. The user operates the user interface displayed on the web browser to change the settings and use the functions.

A user authentication service 303 is a software module for authenticating a user who uses the local UI 301 or the remote UI 302. Although not illustrated, the user authentication service 303 also has a function of allowing an authenticated user to log in to the MFP 101.

The user authentication service 303 authenticates a user who uses the local UI 301 based on a user name and a password input via a keyboard, or an IC card. The user authentication service 303 authenticates a user who uses the remote UI 302 based on a user name, a password, and a one-time password. An IC card reader driver 304 is a driver for controlling the IC card reader 209 to acquire IC card information from an IC card, and to provide the IC card information to the user authentication service 303. The user authentication service 303 includes a function of a password strength calculation unit 306 for calculating the strength of the input password.

### <Password Strength>

The password strength is a numerical value representing how a security level is less easily guessed, in consideration of a target password length, a complexity, and the like. In general, in many cases, a rule that a password needs to include various kinds of characters (numerals, symbols, capital letters, and small letters) together, and characters needs to be longer than a predetermined length (e.g., 8 letters) is established. There is another method of holding, as a dictionary, character strings that can be easily guessed from frequently used keywords such as password, admin, a person's name, an English word, and a keyboard layout (qwerty), to determine that the security is low in a case where an input password matches any of these character strings when the password is input.

In the present disclosure, assume that the methods described above, and/or the password strength digitized using a known technique are used for the password strength calculation. The password strength calculation is performed using the password strength calculation unit 306 of the user authentication service 303. Assume that any one of 5 levels of 1 to 5 determined based on the strength calculation result is returned, but the evaluation method is not limited to this example. The integer value determined by the calculation result of the password strength is the password strength described above visualized on a screen, and expressed by a password strength meter. The password strength meter is displayed in a case where a password used when a user is registered to the MFP 101 is newly registered or edited. Assume that the password strength meter is not displayed on a screen for checking the password at a login time.

### <User Information>

User information managed by the user authentication service 303 will be described. The user authentication service 303 stores the user information in a user information table as in Table 1, and manages the user information. The user information table is a database stored in the HDD 204. A database on a different node on the network may be used, using an encrypted and tamper-proof communication path and storage. The user information table stores a card identification (ID) used for the IC card authentication, a password, a user's role, a mail address, and the like. The setting of the “Password Change at Next Login” is a value that can be created and set by the user at an editing time of the user information, and the user whose setting is “Enabled” is requested to change the password at the next login time.

TABLE 1

| | | | | | Password |
|---|---|---|---|---|---|
| User | | | | | Change at |
| Name | Password | Card ID | Role | Mail Address | Next Login |
| Admin | ******** | F1EABB15•• | Administrator | admin@conon.com | Disabled |
| Alice | ******** | 44E7158E•• | Administrator | alice@conon.com | Disabled |
| Bob | ******** | 045BB438•• | GeneralUser | bob@conon.com | Disabled |
| Carol | ******** | 19E313B6•• | GeneralUser | carol@conon.com | Enabled |
| Dave | ******** | BDFDB35•• | LimitedUser | dave@conon.com | Enabled |

The role is information indicating a user's right of use for the MFP 101. Examples of the role and the right of use are illustrated in a role information table (Table 2). In addition to the role definition provided at the factory shipment time of the MFP 101, a user may be allowed to set a detailed right of use, and create a new role. The setting change in Table 2 indicates an action to change the values set on the MFP 101, such as a user authentication setting described below and a user management setting. Various kinds and a wide variety of network settings and print function settings of the MFP 101 may be changed. Administrator is a role given to an administrator user, and GeneralUser and/or LimitedUser are roles given to general users. Restrictions regarding the print functions of the image forming apparatus (MFP 101) are set on the roles. For example, there is a restriction on the general user not to be able to use the color print function.

TABLE 2

| Role | Right |
|---|---|
| Administrator | setting change allowed, color print allowed, and address |
| | book edit allowed |
| GeneralUser | setting change prohibited, color print allowed, and |
| | address book reference allowed |
| LimitedUser | setting change prohibited, color print prohibited, and |
| | address book reference prohibited |

### <User Authentication Setting>

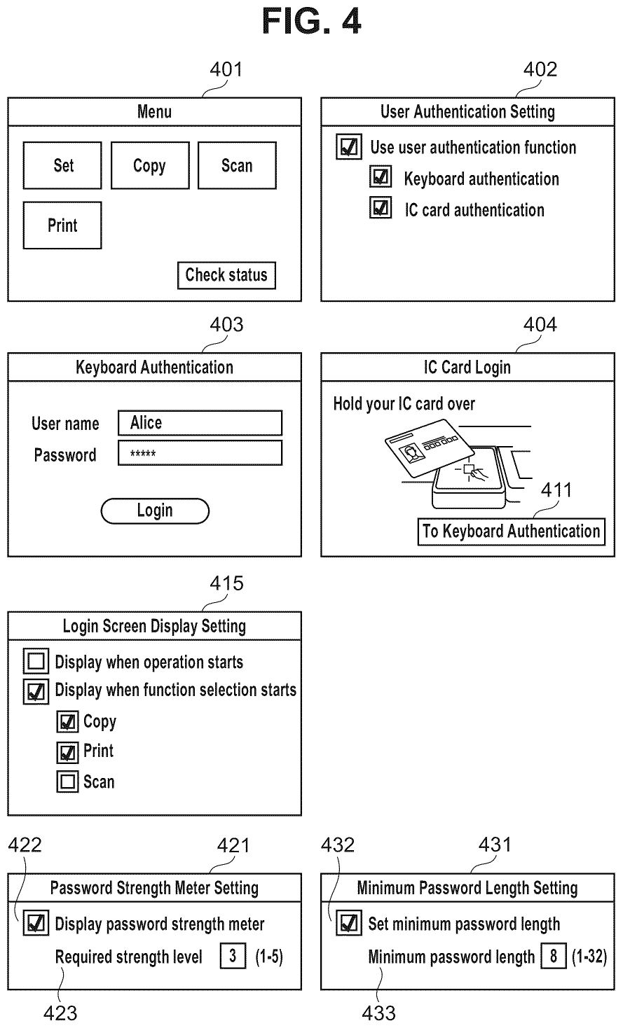

User authentication settings of the MFP 101 will be described. FIG. 4 illustrates an example of a user interface of the user authentication settings of the MFP 101 provided by the local UI 301. The similar UI may be provided to the administrator not only on the local UI 301 but also on the remote UI 302. When the MFP 101 is started up, the local UI 301 displays a “Menu” screen 401 for selecting an application. A user authentication function selectable from a “User Authentication Setting” screen 402 is sometimes referred to as a login function. The MFP 101 has two functions of performing the user authentication based on a user's input from a keyboard, and of performing the user authentication based on an input of an IC card owned by the user.

The user can display the “User Authentication Setting” screen 402 via the “Menu” screen 401. The “User Authentication Setting” screen 402 allows a user to select the user authentication function enabled or disabled. In a case where the user selects the user authentication function enabled, the user can further select one or both of the login functions from a keyboard authentication and an IC card authentication. The “User Authentication Setting” screen 402 illustrates a state where the user authentication function is set enabled and further all the login functions are selected.

The settings selected by the user are stored in the HDD 204, the user authentication service 303 refers to the stored settings, and the login function or login functions based on the user's settings are started up. In a case where the both login functions (keyboard authentication and IC card authentication) are set enabled, the local UI 301 displays an “IC Card Login” screen 404. Pressing a button 411 shifts the “IC Card Login” screen 404 to a “Keyboard Authentication” screen 403, and the keyboard authentication becomes possible.

In a case where only the keyboard authentication is enabled, the “Keyboard Authentication” screen 403 is displayed, and in a case where only the IC card authentication is enabled or both the IC card authentication and the keyboard authentication are enabled, the “IC Card Login” screen 404 is displayed. In the case where only the IC card authentication is enabled, the button 411 on the “IC Card Login” screen 404 is not displayed.

In a case where the user authentication service 303 detects an IC card, the user authentication service 303 refers to account information stored in the HDD 204, and allows the user with the card ID matched with the account information to log in to the MFP 101.

The user authentication service 303 collates the user name and the password input onto the “Keyboard Authentication” screen 403 with the account information stored in the HDD 204, and allows the user with the user name and the password matched with the account information to log in to the MFP 101 when they match each other.

The user authentication service 303 stores the information about the logged-in user in an object called a login context, and transmits the information to other software modules. An example of the information stored in the login context is illustrated in Table 3. In the login context, the logged-in user's user name, the role, and the mail address are stored as illustrated in Table 3. Other software modules permit the use of the software functions based on the login context.

TABLE 3

| Item | Value |
|---|---|
| Login user name | Alice |
| Role | Administrator |
| Mail address | alice@conon.com |

In a case where the login to the MFP 101 has succeeded, the local UI 301 closes the login screen such as the “Keyboard Authentication” screen 403, and shifts the login screen to the “Menu” screen 401. The “Menu” screen 401 provides, after referring to the above-described login context to identify the logged-in user, a menu screen for the logged-in user. The “Menu” screen 401 and the screens for various kinds of functions (copy and scan functions) provide functions that can personalize them according to the user's preference.

A timing to display the login screen can be set on a “Login Screen Display Setting” screen 415. In a case where a “Display when operation starts” is selected, an authentication screen is displayed before the “Menu” screen 401 is displayed after the MFP 101 is started up. When “Display when function starts” is selected, an authentication can be requested in a case where a function such as copy, print, and scan functions is used. Since the “Menu” screen 401 is displayed when the MFP 101 is started up, the authentication screen is displayed when the function set via the menu to request an authentication is selected.

In a case where a password strength meter setting is selected from the setting items via the “Menu” screen 401, a “Password Strength Meter Setting” screen 421 is displayed. A “Display password strength meter” setting 422 is a setting to set whether to display the password strength meter. In a case where the setting is enabled, the password strength meter is displayed when the password is input. In a case where the setting is disabled, the password strength meter is not displayed.

A “Required strength level” setting 423 is a setting for prohibiting the password setting, in a case where the password strength calculation unit 306 calculates the input password, and the result of the calculation does not satisfy the value set in the “Required strength level” setting 423. The calculation result of the strength is expressed by an integer value from among 5 levels of 1 to 5. For example, in a case where the “Required strength level” setting 423 is set to “3”, the values of the strength calculation results of strength 1 and strength 2 are prohibited from being input. In a case where the “Required strength level” setting 423 is set to “1”, since even when the strength calculation result is level 1, the operation to allow the user to log in is performed, and the strength is not restricted in this case. In the present exemplary embodiment, a description is given assuming that the “Display password strength meter” setting 422 is set to be enabled, and the “Required strength level” setting 423 is set to “3” as initial settings.

In a case where a setting of a minimum password length is selected from the setting items via the “Menu” screen 401, a “Minimum Password Length Setting” screen 431 is displayed. The “Minimum Password Length Setting” screen 431 is a setting screen for defining the minimum character length required at a password setting time. A “Set minimum password length” setting 432 is a setting of whether to be enabled or disabled. In a “Minimum password length” setting 433, an integer value from among 1 to 32 can be set. The number of settable characters may be expanded depending on the system configuration. In the present exemplary embodiment, a description is given assuming that the “Set minimum password length” setting 432 is set to ON, and the “Minimum password length” setting 433 is set to “8” as initial values.

### <User Management>

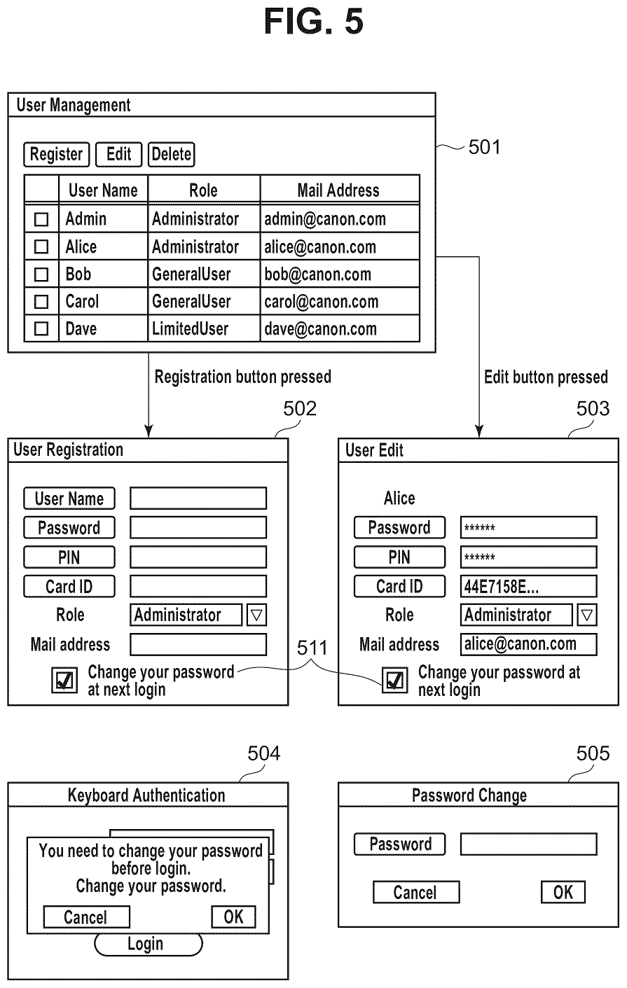

FIG. 5 illustrates an example of UIs for managing the user accounts of the MFP 101 provided by the local UI 301. The similar UIs may be provided to the administrator not only by the local UI 301 but also by the remote UI 302.

A “User Management” screen 501 is for managing a user account list. Only an administrator having the administrator role can access the user account list. The “User Management” screen 501 provides functions of being able to register a new user account, and to select a registered account to edit or delete.

For example, in a case of registering a user, the local UI 301 displays a “User Registration” screen 502 in a case where a user “Admin” presses a “Register” button on the “User Management” screen 501. On the “User Registration” screen 502, a user name, a password, a card ID, a mail address, and a role can be registered and stored.

In a case of editing a user, in a case where the user “Admin” selects an account of “Alice”, and presses an “Edit” button, the local UI 301 displays a “User Edit” screen 503. On the “User Edit” screen 503, a password, a card ID, a mail address, a role, and the like can be edited and stored.

### <Operation Flow of User Registration and Editing>

Processing of the user authentication service 303 for displaying the password strength meter on the local UI 301 will be described. In the present exemplary embodiment, a procedure in a flowchart described below is recorded in a software program in the local UI 301 or the user authentication service 303. Software programs are stored in a nonvolatile storage such as the ROM 202 and the HDD 204, loaded in the RAM 203, and executed by the CPU 201 to implement the flow illustrated in the flowchart. The software programs such as the local UI 301 and the user authentication service 303 provide application programming interfaces (APIs) to each other, and the software programs operate in collaboration with each other, by mutually using the APIs. In the description of the operation flow, calling of the APIs is not described.

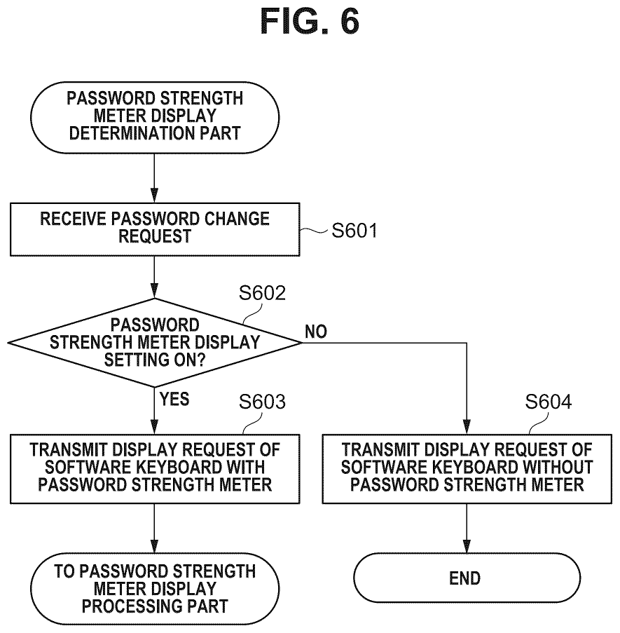

FIG. 6 is a flowchart illustrating an operation flow of determining whether to display the password strength meter when a password is set via the local UI 301.

In step S601, when the password button is pressed on the “User Registration” screen 502 or the “User Edit” screen 503, the user authentication service 303 receives a password change request. In step S602, the user authentication service 303 checks whether the “Display password strength meter” setting 422 is enabled (ON). In a case where the “Display password strength meter” setting 422 is ON (YES in step S602), the processing proceeds to step S603. In step S603, the user authentication service 303 transmits a display request of a software keyboard 711 with the password strength meter to the local UI 301. In a case where the “Display password strength meter” setting 422 is OFF (disabled) (NO in step S602), the processing proceeds to step S604. In step S604, the user authentication service 303 transmits a display request of a software keyboard 701 without the password strength meter to the local UI 301. In the case where the “Display password strength meter” setting 422 is OFF (disabled), the processing is not different from the conventional password setting processing, and thus the description thereof is omitted.

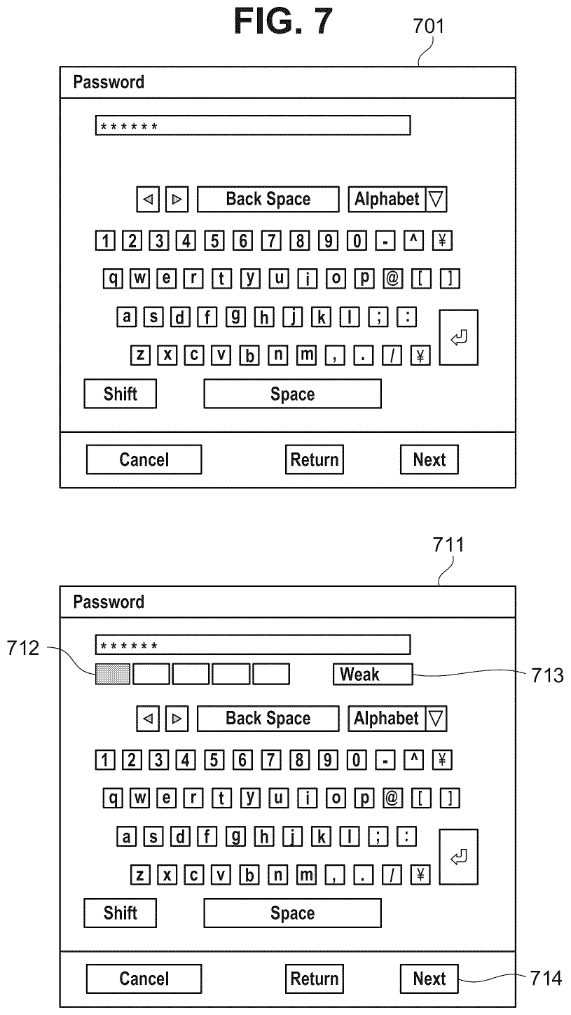

FIG. 7 is a diagram illustrating software keyboards controlled by the local UI 301. The software keyboard 711 with the password strength meter includes a meter 712 indicating a password strength based on an input of a password, and a text area 713 indicating a password strength level or an error content. In a case where the input password does not satisfy the setting, it is possible to control a “Next” button 714 so that the “Next” button 714 is unable to be pressed.

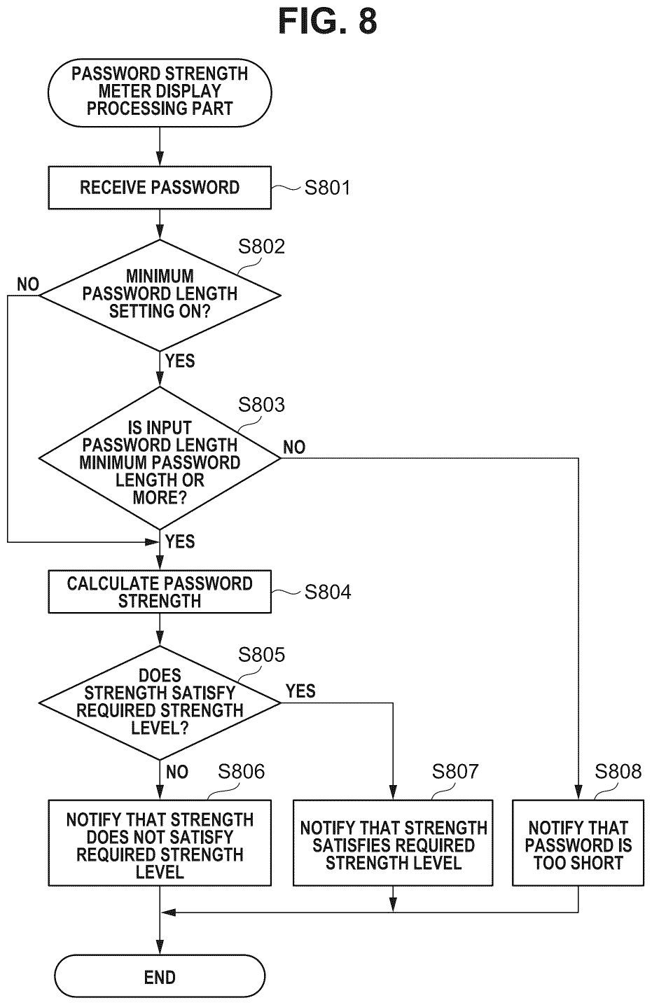

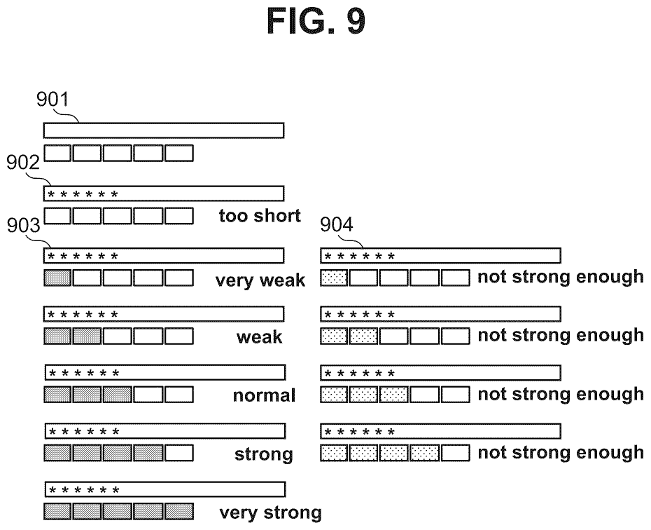

With reference to FIGS. 8 and 9, a description will be given of display contents of the strength meter when a password is input.

FIG. 8 is a flowchart illustrating an operation flow of display processing of the password strength meter, and FIG. 9 is a diagram illustrating the display contents of the password strength meter.

In step S603 in FIG. 6, when the display request of the software keyboard 711 with the password strength meter is transmitted from the user authentication service 303 to the local UI 301, the local UI 301 displays the software keyboard 711 with the password strength meter. At this time, the display content of the password strength meter is in an initial state. A display content 901 illustrates the display content of the initial state of the password strength meter. In the initial state, the meter 712 is in a state where there is no change in the display content such as a display color and the text area 713 includes no display.

When a user presses buttons on the software keyboard to input a password, the local UI 301 transmits the password input to the user authentication service 303 to display the password strength meter.

In step S801, the user authentication service 303 receives the password from the local UI 301. In step S802, the user authentication service 303 checks whether the “Set minimum password length” setting 432 is enabled (ON).

In a case where the setting of the minimum password length is ON (YES in step S802), the processing proceeds to step S803. In step S803, the user authentication service 303 checks whether the length of the input password is the length in the setting of the “Minimum password length” setting 433 or more. In a case where the setting is not satisfied (NO in step S803), the processing proceeds to step S808. In step S808, the user authentication service 303 notifies the local UI 301 that the password length is too short. Upon receiving the notification indicating that the password length is too short, the local UI 301 displays an error message indicating that the password is too short, in the text area 713 as illustrated in a display content 902. At this time, the display of the meter 712 remains in the initial state.

In the present exemplary embodiment, whether the setting of the password minimum length is satisfied is checked first, because the password length is one of the factors to determine the password strength when the password strength is calculated. Depending on the system of the built-in device or the like, there is a case where the password minimum length is defined from the beginning, and the system of the password strength meter is introduced later. In such a case, the user authentication service 303 checks first whether the setting of the password minimum length is satisfied, because calculating the password strength becomes worthless in a case where the predefined password minimum length value is not satisfied. Regarding the password minimum length, equivalent processing may be performed based on an internally defined value without the setting item as in the present disclosure.

In a case where the setting of the password minimum length is disabled (OFF) in step S802 (NO in step S802) or the setting of the password minimum length is satisfied in step S803 (YES in step S803), the processing proceeds to step S804. In step S804, the user authentication service 303 calculates the password strength of the input password by the password strength calculation unit 306. In step S805, the user authentication service 303 checks whether the calculated strength satisfies the value of the “Required strength level” setting 423. In a case where the user authentication service 303 determines that the required strength level is not satisfied (NO in step S805), the processing proceeds to step S806. In step S806, the user authentication service 303 notifies the local UI 301 that the strength does not satisfy the required strength level. Upon receiving the notification indicating that the strength dose not satisfy the required strength level, the local UI 301 displays a display content 904. The meter 712 displays the strength level of the input password, but the strength level is expressed using an error display and/or a color display that are different from the appropriate state. The text area 713 displays a message indicating that the strength is not enough. At this time, the “Next” button 714 is grayed out and cannot be pressed.

In step S805, in a case where the required strength level is satisfied (YES in step S805), the processing proceeds to step S807. In step S807, the user authentication service 303 notifies the local UI 301 that the required strength level is satisfied. Upon receiving the notification indicating that the strength satisfies the required strength level, the local UI 301 displays a display content 903. The meter 712 displays the strength level of the input password, and the text area 713 displays a message indicating the strength level. At this time, the grayed out of the “Next” button 714 is canceled, and the “Next” button 714 becomes pressable.

### <Operation Flow at Login Time>

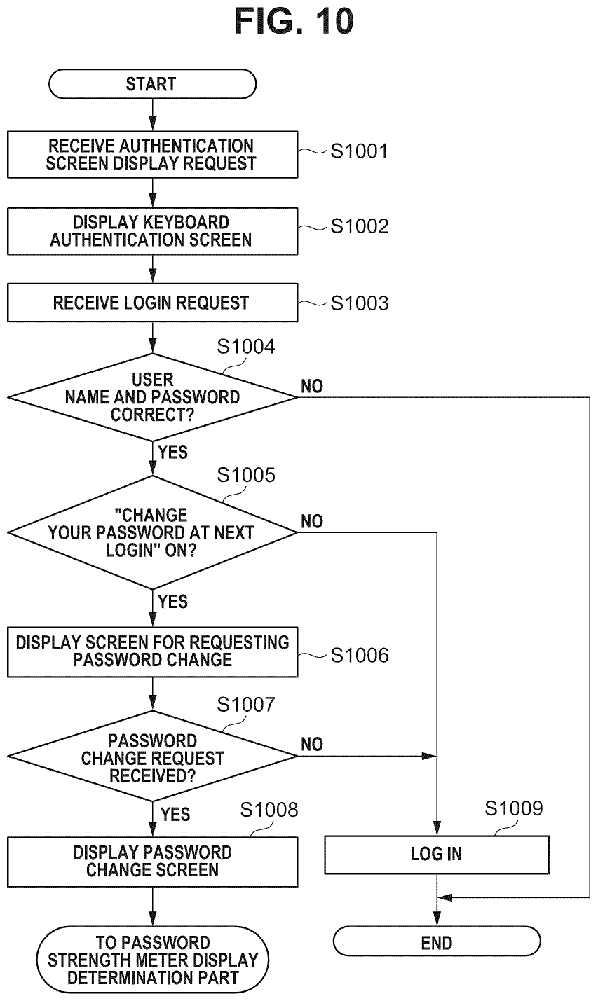

FIG. 10 is a flowchart illustrating an operation flow performed in a case where a password is changed at a login time. The setting of the “Change your password at next login” setting 511 provided on the “User Registration” screen 502 and the “User Edit” screen 503 is enabled, the password change is requested at the next login time of the corresponding user.

In a case where the “Login Screen Display Setting” screen 415 is set at the operation start time, the authentication screen is displayed before the “Menu” screen 401 is displayed. The displayed authentication screen is the “Keyboard Authentication” screen 403 or the “IC Card Login” screen 404, depending on the setting on the “User Authentication Setting” screen 402. In a case where the “Login Screen Display Setting” screen 415 is set at the function selection time, the “Menu” screen 401 is displayed without the authentication, and the authentication screen is displayed when a function button of “Copy”, “Print”, or “Scan” is pressed. In the present exemplary embodiment, as an example, a description is given of a case where the keyboard authentication is set on the “User Authentication Setting” screen 402, and the display at the copy function start time is set on the “Login Screen Display Setting” screen 415.

In step S1001, when the “Copy” button is pressed on the “Menu” screen 401, an authentication screen display request is transmitted from the local UI 301 to the user authentication service 303. In step S1002, upon receiving the authentication screen display request, the user authentication service 303 displays the “Keyboard Authentication” screen 403. In step S1003, the user authentication service 303 receives a login request when the user name and the password are input on the “Keyboard Authentication” screen 403 and the login processing is performed. In step S1004, upon receiving the login request, the user authentication service 303 checks whether the user name and the password are correct. In a case where the user name and/or the password are/is incorrect (NO in step S1004), the processing ends.

In a case where the user name and the password are correct (YES in step S1004), the processing proceeds to step S1005. In step S1005, the user authentication service 303 refers to the user information about the corresponding user described in Table 1, to check whether the setting of the “Change your password at next login” setting 511 is enabled (ON). In a case where the setting of the “Change your password at next login” setting 511 is disabled (OFF) (NO in step S1005), the processing proceeds to step S1009. In step S1009, the user authentication service 303 performs login processing, and then the processing of this flowchart ends. In a case where the setting of the “Change your password at next login” setting 511 is enabled (ON) (YES in step S1005), the processing proceeds to step S1006. In step S1006, the user authentication service 303 instructs the local UI 301 to display a “Keyboard Authentication” screen 504 for requesting the password change. In step S1007, the user authentication service 303 checks whether an “OK” button or a “Cancel” button is pressed on the “Keyboard Authentication” screen 504 for requesting the password change. In a case where the “Cancel” button is pressed (NO in step S1007), the processing proceeds to step S1009. In step S1009, the user authentication service 303 performs login processing, and then the processing ends. In the present exemplary embodiment, even in a case where the password change is canceled, the user can log in, but login may not be possible without changing the password.

In a case where the “OK” button is pressed on the “Keyboard Authentication” screen 504 for requesting the password change (YES in step S1007), the processing proceeds to step S1008. In step S1008, the user authentication service 303 instructs the local UI 301 to display a “Password Change” screen 505. In a case where a “Password” button on the “Password Change” screen 505 is pressed, since the processing performed at this time is similar to the processing in steps S601 to S604 performed in the case where the “Password” button is pressed on the “User Registration” screen 502 or the “User Edit” screen 503 described above, the description thereof is omitted.

In a case where the “Display password strength meter” setting 422 is enabled, the software keyboard 711 with the password strength meter is called, but the display processing of the password strength meter is similar to the display processing performed in steps S801 to S808, and the detailed description thereof is omitted.

### <Control of Password Strength Meter on Remote UI>

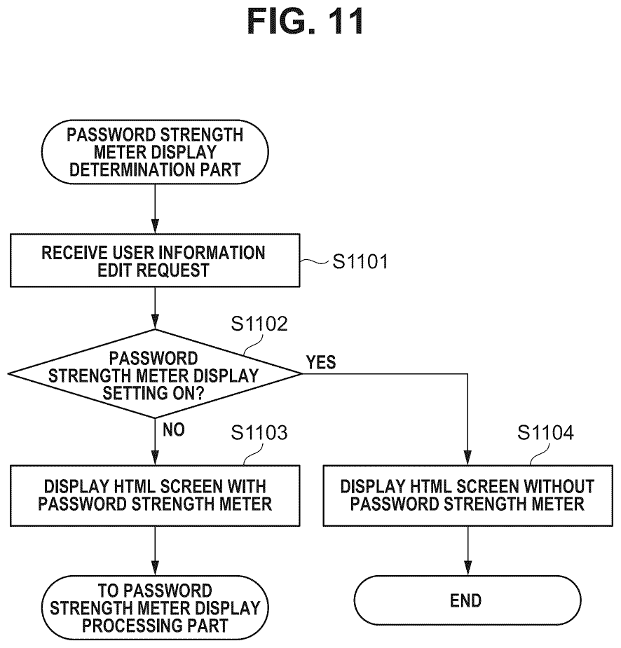

Processing of the user authentication service 303 displaying the password strength meter on the remote UI 302 will be described. FIG. 11 is a flowchart illustrating an operation flow of determining whether to display the password strength meter on the “User Registration” screen 502 on the remote UI 302.

The “User Management” screen 501 similar to that displayed on the local UI 301 is also displayed on the remote UI 302. The user registration and the edit are possible as on the local UI 301, and thus the detailed description thereof is omitted. The user registration screen and the user edit screen are almost the same, and the user registration processing will be described as an example. In the present exemplary embodiment, it is described that the user authentication service 303 displays an HTML screen, and it means that the user authentication service 303 causes an external apparatus to display the HTML screen on a display unit of the external apparatus by transmitting HTML for displaying the HTML screen. The method of providing the password strength meter is not limited to the example, regarding both the local UI 301 and the remote UI 302.

In step S1101, in a case where a “Registration” button for registering a user is pressed on the “User Management” screen 501 on the remote UI 302, the user authentication service 303 receives a user information edit request. In step S1102, the user authentication service 303 checks whether the “Display password strength meter” setting 422 is enabled (ON). In a case where the “Display password strength meter” setting 422 is ON (YES in step S1102), the processing proceeds to step S1103. In step S1103, the user authentication service 303 displays an HTML screen with the password strength meter. On the other hand, in a case where the password strength meter display setting is OFF (NO in step S1102), the processing proceeds to step S1104. In step S1104, the user authentication service 303 displays an HTML screen without the password strength meter.

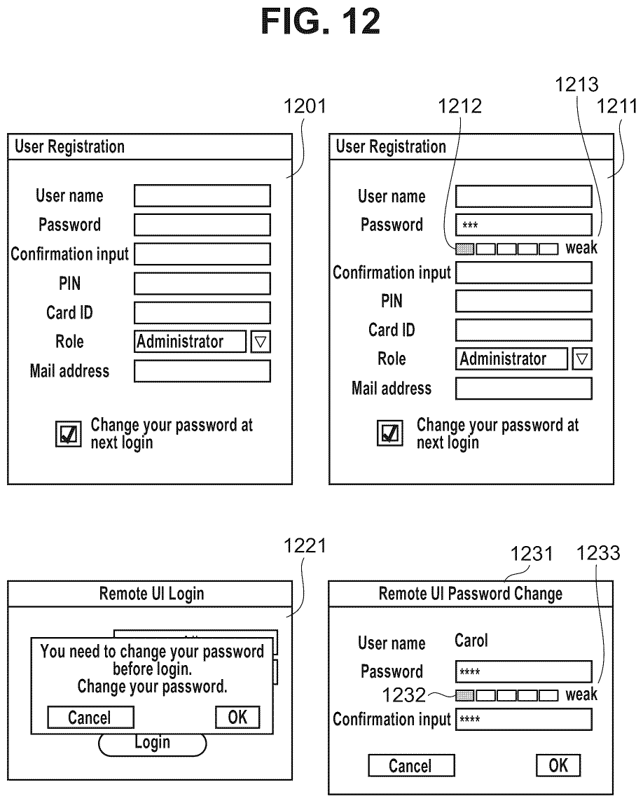

FIG. 12 is a diagram illustrating user registration screens on the remote UI 302. In the case where the HTML screen without the password strength meter is displayed in step S1104, the HTML screen like a “User Registration” screen 1201 is displayed. In the case where the HTML screen with the password strength meter is displayed in step S1103, the HTML screen like an HTML screen 1211 with the password strength meter is displayed. The HTML screen 1211 with the password strength meter is similar to the software keyboard 711 with the password strength meter displayed on the local UI 301. The HTML screen 1211 with the password strength meter includes a meter 1212 displaying the password strength based on the input password, and a text area 1213 indicating a strength level of the password or a content of an error. In the initial state, the meter 1212 is in a state where there is no change in the display content such as a display color and there is nothing displayed in the text area 1213.

Display processing of the password strength meter performed when a password is input on the HTML screen 1211 with the password strength meter on the remote UI 302 is similar to the display processing performed in steps S801 to S808, and thus the description thereof is omitted.

Processing performed in a case where the password is to be changed at a login time via a “Remote UI Login” screen 1221 on the remote UI 302 will be described. Assume that the login is performed by a user whose setting of the “Change your password at next login” setting 511 is set to enabled (ON). In step S1003, when a user name and a password are input via the “Remote UI Login” screen 1221 and the login processing is performed, the user authentication service 303 receives a login request. Processing performed in steps S1003 to S1009 is the same as the processing performed at the login time of the local UI 301, thus the description thereof is omitted.

In the case of the remote UI 302, a “Remote UI Password Change” screen 1231 is displayed in step S1008 when the password change request is received. The “Remote UI Password Change” screen 1231 includes a meter 1232 indicating the password strength based on the password input, and a text area 1233 indicating a password strength level or an error content.

Display processing of the password strength meter performed when a password is input on the “Remote UI Password Change” screen 1231 on the remote UI 302 is similar to the display processing performed in steps S801 to S808, and thus the description thereof is omitted.

As describe above, the MFP 101 according to the present exemplary embodiment can provide a configuration in which a setting of a strength level of a password required when a user is registered to the MFP 101 can be made, and thus can provide a secure and highly convenient image forming apparatus adaptable to an installation environment.

The present disclosure can also be realized by processing of supplying a program for implementing one or more functions of the above-described exemplary embodiments to a system or an apparatus via a network or a storage medium, and one or more processors in the system or the apparatus reading and executing the program. The present disclosure can also be realized by a circuit (e.g., application specific integrated circuits (ASIC)) that can implement one or more functions.

The exemplary embodiments are described above in detail, but the present disclosure is not limited to the specific exemplary embodiments. The exemplary embodiments can be modified and changed within the gist of the present disclosure described in the claims.

According the present disclosure, it is possible to provide a setting method of a required password strength level, and accordingly to provide a secure and highly convenient information processing apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-028263, filed Feb. 28, 2024, which is hereby incorporated by reference herein in its entirety.

What is claimed is:

1. An image forming apparatus configured to register a password of a user who uses an image forming function, and/or edit the password, the image forming apparatus comprising:
at least one first processor and at least one first memory coupled to the first processor and having stored thereon instructions, when executed by the first processor, and cooperating to act as:
a password strength calculation unit configured to calculate a strength of the password input by the user;
a request unit configured to request a display of a screen including a password strength meter for indicating a strength level determined based on the calculated strength; and
a setting unit configured to set a strength level of the password to be set on the image forming apparatus,
wherein the strength level determined based on the calculated strength and the set strength level are compared to change a display content of the password strength meter based on a result of the comparison.

2. The image forming apparatus according to claim 1, wherein the request unit requests a display unit of the image forming apparatus to display a screen of a software keyboard including the password strength meter.

3. The image forming apparatus according to claim 2, wherein the request unit requests a display unit of an external apparatus to display a HyperText Markup Language (HTML) screen including the password strength meter.

4. The image forming apparatus according to claim 3, wherein the password strength calculation unit acquires the password input via the screen displayed on the display unit of the image forming apparatus or via the HTML screen displayed on the display unit of the external apparatus, and calculates the strength of the acquired password.

5. The image forming apparatus according to claim 4, wherein the request unit provides a display request of the screen including the password strength meter indicating as a display content that the password is appropriate, in a case where the password satisfies the required strength level as the result of the comparison of the strength level determined based on the calculated strength and the set strength level.

6. The image forming apparatus according to claim 5, wherein the request unit provides a display request of the screen including the password strength meter indicating as a display content that the password is not appropriate, in a case where the password does not satisfy the required strength level as the result of the comparison of the strength level determined based on the calculated strength and the set strength level.

7. The image forming apparatus according to claim 6, wherein the display content of the password strength meter indicating that the password is not appropriate is expressed by an error display and/or a color display.

8. The image forming apparatus according to claim 1, wherein the screen including the password strength meter is displayed before a menu screen for selecting the image forming function is displayed, in a case where the password is changed when the user logs in to the image forming apparatus.

9. A control method for an image forming apparatus configured to register a password of a user who uses an image forming function, and/or edit the password, the control method comprising:
calculating a strength of the password input by the user;
requesting a display of a screen including a password strength meter for indicating a strength level determined based on the calculated strength;
setting a strength level of the password to be set on the image forming apparatus;
comparing the strength level determined based on the calculated strength and the set strength level; and
changing a display content of the password strength meter based on a result of the comparison.

10. A non-transitory computer readable recording medium storing instructions for causing a computer to execute a control method of an image forming apparatus configured to register a password of a user who uses an image forming function, and/or edit the password, the control method comprising:
calculating a strength of the password input by the user;
requesting a display of a screen including a password strength meter for indicating a strength level determined based on the calculated strength;
setting a strength level of the password to be set on the image forming apparatus;
comparing the strength level determined based on the calculated strength and the set strength level; and
changing a display content of the password strength meter based on a result of the comparison.
